(19) United States
(12) Patent Application Publication
(10) Pub. No.: US 2023/0132322 A1
(43) Pub. Date: Apr. 27, 2023

(54) HOOKAH COAL TONGS AND METHOD OF USING THE SAME

(71) Applicant: KIRACO LLC, Northridge, CA (US)

(72) Inventor: Albert Kirakosian, Northridge, CA (US)

(21) Appl. No.: 17/510,102

(22) Filed: Oct. 25, 2021

(51) Int. Cl. A24F 1/30

(52) U.S. Cl. CPC A24F 1/30

(57) ABSTRACT

A pair of tongs including pins for engaging an object such as a hookah coal about an axis and allowing the object to rotate relative to the axis. A method of rotating a coal used on hookah including engaging the coal about and axis and lifting the coal, allowing the coal to rotate about the axis.

### BACKGROUND

A hookah is a device used to smoke tobacco. The device has its origins in the Middle East and Near East regions. A typical hookah 10 as shown in FIG. 1, includes a water reservoir 12. A plug, cap or gasket 14 (either of which is referred to herein as a “cap” for illustrative purposes). The cap caps the reservoir. A stem 16 penetrates the cap such that a first end 18 of the stem is external of the reservoir whereas a second end 20 of the stem opposite the first end is within the reservoir. At least one hose 22 with optionally a mouthpiece (now shown) also penetrates the cap. To use the hookah, the reservoir is partially filled with water 25 leaving a head space 26 within the reservoir free of water while submerging the second end 20 of the stem 18 within the water. Each hose 22 extends within the head space 26 of the reservoir above the water. A tobacco bowl 28 is connected to the first end 18 of the stem. Specifically, the tobacco bowl 28 includes an opening 30 extending to its lower end for receiving the first end 18 of the stem. The tobacco bowl defines a conduit 32 extending from the opening 30 to interior of the bowl. Tobacco 31 to be smoked is placed within a tobacco support 34 defined within the bowl external of the conduit. A perforated coal plate 36 is mounted over the bowl. A dish 37 extends from the stem 16 and provides a shelf for resting tongs that are used to rotate the coal as well as serve to collect ashes that may fall from the hookah bowl.

Hookah tobacco, is often referred to as “massell.” Massell is a mixture of tobacco, molasses, and often a flavor or fruit extract. The molasses and fruit extract add a substantial amount of moisture to the massell that is missing in conventional tobacco. This added moisture makes massell more sensitive to the elements relative to conventional tobacco. To smoke the hookah, the massell or tobacco is placed within the tobacco support 34 of the bowl. The coal plate 36 is then mounted on top of the bowl covering the massell. Lit coals 37 are placed on top of the coal plate. The heat from the coals ignites the massell. Smoke generated by the ignited massell travels through the conduit and the first end of the stem and exits in the water through the second end of the stem. The water cooled the smoke exits the reservoir through each hose 22 and corresponding mouth piece as the user inhales through the mouth piece.

During smoking of a hookah, the coals burn down and the surface of the coal touching the coal plate reduces the heat it produces. As such, the coal is rotated such that an upper surface of the coal away from the coal plate is rotated to rest on the coal plate to provide more heat to the coal plate. Tongs are used in their normal fashion to grab opposing surfaces of the coal to rotate the coal. Specifically, a user aligns the opposite arms of the tongs on the opposite sides of the of the hot coal and then twists their hand about the longitudinal axis of their arm such that the lower surface of the coal is rotated to be the upper surface of the coal while the upper surface of the coal is rotated to become the lower surface of the coal and contact the coal plate. Similarly, when igniting a coal on heated surface so that it can be used on a hookah, once a lower surface adjacent heater surface is heated the tongs are used to grab on the opposite side surfaces of the coal, and the user rotates the coal by twisting their hand and places the upper surface of the coal against the heated surface. This twisting tend of the hands tends to be uncomfortable.

### SUMMARY

In an example embodiment a pair of tongs, includes a first arm including a first end opposite a second end and an inner surface, and a second arm including a first end opposite a second end and an inner surface. The first arm and the second arm are coupled together at, or proximate, their first ends, such that the inner surface of the first arm faces the inner surface of the second arm, and the second end of the first arm is biased away from the second end of the second arm. A first pin including a tip extends from the inner surface of the first arm in a direction toward the second arm. A second pin including a tip extends from the inner surface of the second arm and in a direction towards the first arm. The first and second pins are configured for engaging an object with their corresponding tips, such that when the tips engage the object, no other part of the tongs engages the object. In another example embodiment, the tongs further include a first prong extending from the first arm defining a first slot therebetween, and a second prong extending from the second arm defining a second slot therebetween. In an example embodiment, a first slot is formed between the first arm and the first prong and a second slot is formed between the second arm and the second slot. In yet another example embodiment, the first prong extends from proximate the second end of the first arm and in a direction away from the second end and toward the first end of the first arm, and the second prong extends from proximate the second end of the second arm and in a direction away from the second end and toward the first end of the second arm. In a further example embodiment, the first pin is located proximate the second end of the first arm and the second pin is located proximate the second end of the first arm. In yet a further example embodiment, each of the first and second pins is integrally formed with its corresponding arm. In another example embodiment, each of the first and second pins is attached to its corresponding arm. In yet another example embodiment, when the two arm second ends are compressed towards each other, a tip of the first pin engages a tip of the second pin. In an example embodiment, when the first and second tips engage the object along an axis below a center of gravity of the object, the object will rotate about the axis when lifted off a surface. In any of the aforementioned example embodiments, the object is a coal used in hookah to burn tobacco.

In a further example embodiment, a method of rotating a coal for use on a hookah includes engaging the coal with opposite pins of a pair of tongs along an axis and lifting the engaged coal allowing the coal to rotate about the axis due to its own weight. In yet a further example embodiment, the method further includes pressing one of the opposite pins towards the other of the opposite pins for stopping the rotation of the coal. In an example embodiment, the axis is below a center of gravity of the coal prior to lifting. In an example embodiment, engaging the coal includes pressing one of the opposite pins towards the other of the opposite pins.

### BRIEF DESCRIPTION OF THE DRAWINGS

FIG. 1 shows hookah of the prior art.

FIG. 2 is a perspective view of an example embodiment coal handling tongs.

FIG. 3 is a top view of the example embodiment tongs, shown in FIG. 2, engaging a coal.

FIG. 4 is a side view of the example embodiment tongs, shown in FIG. 2, engaging a coal.

FIG. 5 is a side view of the example embodiment tongs, shown in FIG. 2, engaging a rotated coal.

FIG. 6 is a front view of a hookah with the example embodiment tongs, shown in FIG. 2, hang thereon.

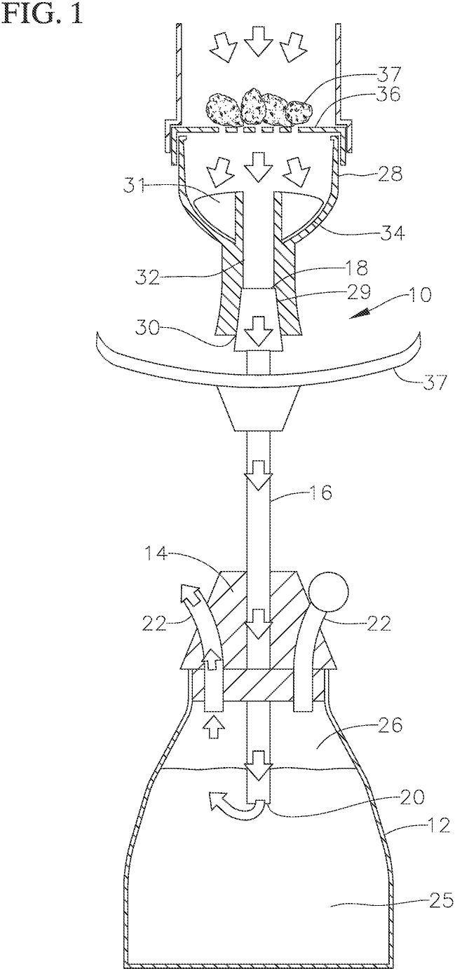

### DETAILED DESCRIPTION

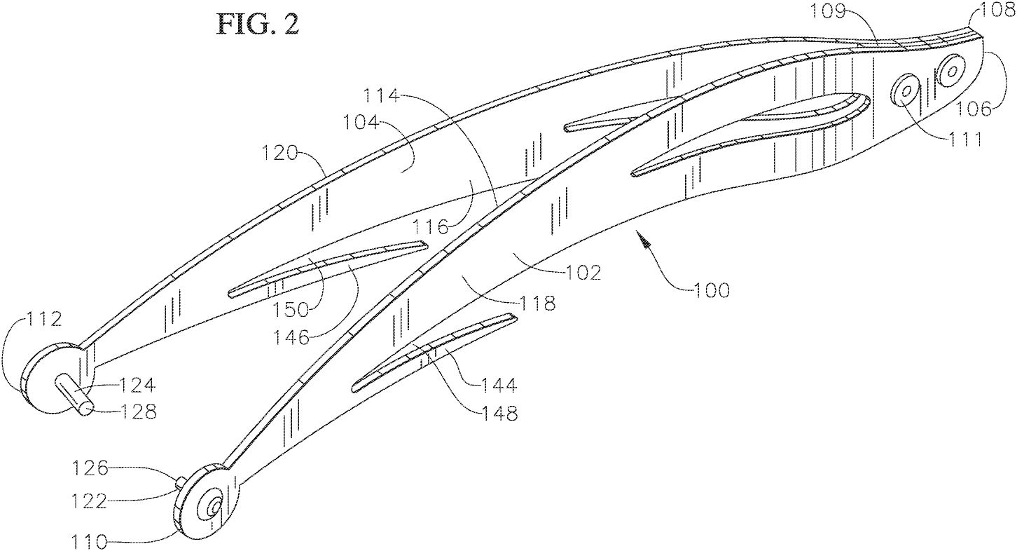

In an example embodiment a pair of coal handling tongs 100 are provided as shown in FIG. 2. The tongs include a pair of opposite arms, i.e., a first arm 102 and a second arm 104, that are coupled to each other. Each arm has a first end 106, 108 opposite a second end 110, 112. Each arm has an inner surface 114, 116 and an outer surface 118, 120. The inner surface 114 of the first arm faces the inner surface 116 of the second arm. The arms are coupled together at, or proximate, their first ends 106, 108. A spacer 109 may be used to space the arms apart proximate their first ends where the arms are coupled together. In an example embodiment, the first arm is connected to the spacer at, or proximate the first arm’s first end and the second arm is connected to an opposite side of the spacer at, or proximate the second arm’s first end. With this embodiment, the spacer serves to couple the arms together without the arms being directly connected to each other. In an example embodiment, the spacer may be connected or coupled to the inner or outer surface of each arm. The arms may be coupled together at, or proximate, their first ends using one or more fasteners 111 or may be adhered to each other or to the spacer, or the may be coupled together by a connector that may also act as a spacer.

The second ends of the arms are biased away from each other. In an example embodiment, a spring (not shown) may be provided for biasing the arms. In a preferred example embodiment, the arm second ends are biased away from each other because of their shape. In other words, each arm is bend longitudinally such that when the two arms are coupled to each other at, or proximate, their first ends, their corresponding second ends are spaced apart from each other. This longitudinal bending of each arm creates the bias of the arms proximate their second ends. In this regard, releasing the second ends after they are pressed toward each other causes them to bias away from each other. In addition, the spacing of the arms, as for example caused by the spacer 109, may also control the amount of the bias of the arms after they are released from being pressed together.

A first pin 122 extends transversely from the inner surface of the first arm at, or proximate, the second end of the first arm and in a direction toward the second arm. A second pin 124, extends transversely from the inner surface of the second arm at, or proximate the second end of the second arm and in a direction toward the first arm. Ends or tips 126, 128 of the pins are used to engage opposite side surfaces 127, 129, the coal for rotating it. The ends 126, 128 of the pins in example embodiments may be pointy, flat or rounded. The ends of the pins extend far enough along their corresponding pin longitudinal axes 130, 132 away from their arm corresponding inner surfaces 114, 116 such that when the pins engage a coal 134, no other part of the prongs, expect for the pins, engage the coal, as for example shown in FIG. 2.

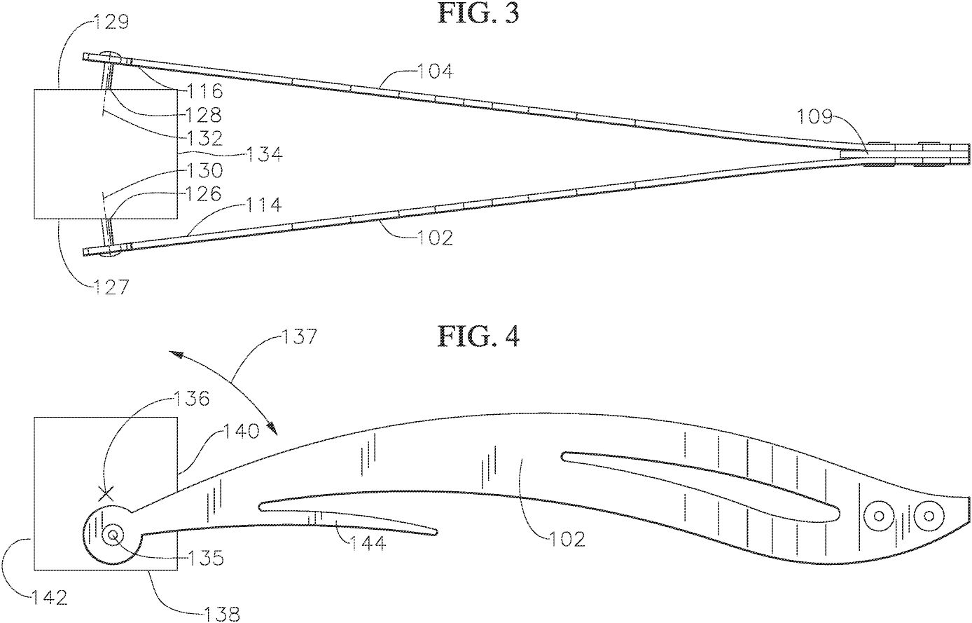

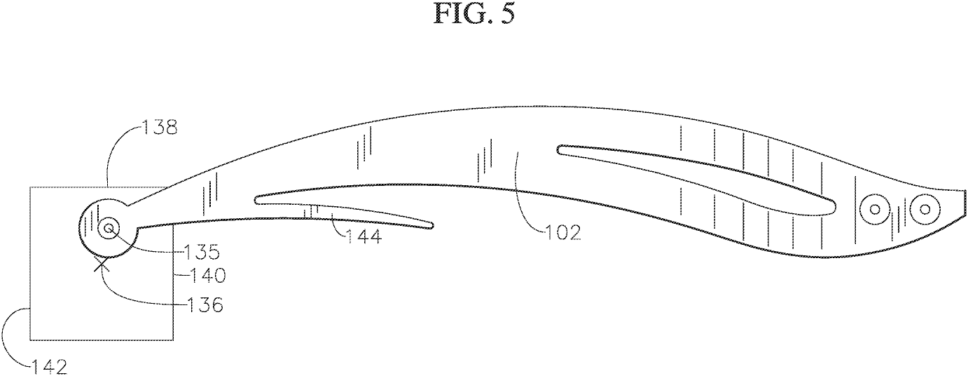

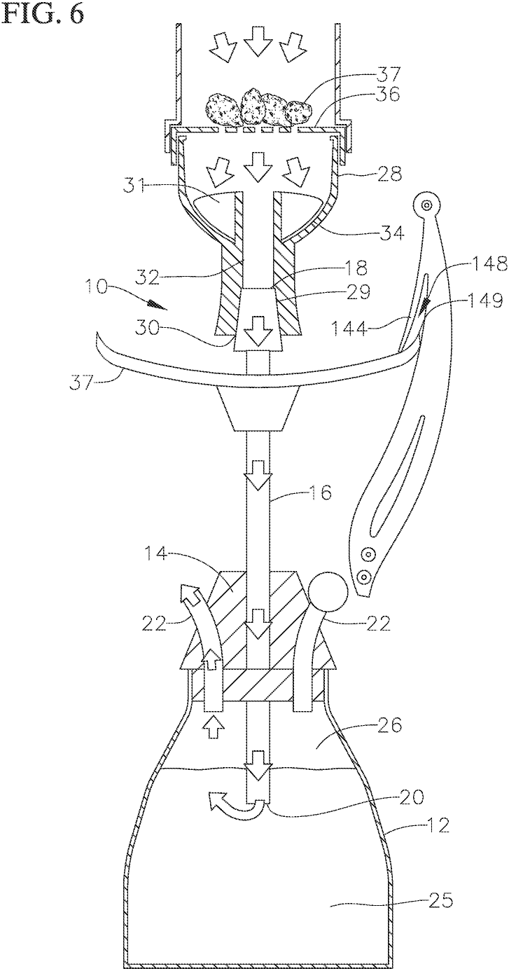

With this embodiment a user engages opposites sides of the coal with the pins 122, 124 the along an axis 134 below the center of gravity 136 of the coal, as shown in FIG. 3. As the user lifts the tongs and the coal, the coal, due to its weight, will rotate (clockwise or counterclockwise as shown by arrow 137 in FIG. 4) about the axis 135 such that its upper surface 138 rotates due to the coal weight to become its lower surface, as shown in FIG. 5, allowing the user to place the rotated upper face 138 of the coal on the coal plate. A user may also press the arms harder towards each other to stop the rotation when the coal is lifted when another face, such as side face 140 or 142 moves to the lower position. It should be understood that is some embodiments, when the pins engage the coal about the axis 134, the pin longitudinal axes 130, 132 may not be aligned with the axis 134, as for example shown in FIG. 3. In an example embodiment, when the two arm second ends are compressed towards each other the tips of the two pins engage each other.

In an example embodiment, a prong 144, 146 may extend obliquely from each arm defining a slot 148, 150 in its corresponding arm. Each prong may be integrally formed with its corresponding arm or it may be separately formed and attached/connected to its corresponding arm. In an example embodiment, the prongs extend from proximate the second an end 110, 112 in a direction away from the second end of their corresponding arms and toward their first corresponding ends 106, 108 of their corresponding arms. In another the example embodiment, the prongs extend from a location proximate the first ends and in a direction away from the first ends of their corresponding arms. When not in use, the tongs may be hung on the dish 37 of the hookah by placing the prongs on the plate such that an end 149 of the dish is received within the slots formed between the arms and their corresponding prongs, as for example shown in FIG. 5. In an example embodiment, the weight of the tongs is balanced such that the tongs can be hung on the dish 37 only the tips of the prongs engaging the dish with or without an end of the dish entering the slots 148, 150.

The descriptions of the example embodiment tongs and methods herein are in relation to a coal used to burn hookah tobacco. In other example embodiments, the tongs and methods described herein may be used to engage and rotate other objects besides hookah coals. Moreover, the coal or other object being rotated can have shapes other than the cubical shape disclosed herein. For example, the object or coal may be cylindrical, spherical or have any other shape.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims. Although relative terms such as “outer,” “inner,” “upper,” “lower,” “below,” “above,” and similar terms have been used herein to describe a spatial relationship of one element to another, it is understood that these terms are intended to encompass different orientations of the various elements and components of the invention in addition to the orientation depicted in the figures. Additionally, as used herein, the term “generally,” “about,” and similar terms are used as terms of approximation and not as terms of degree, and are intended to account for the inherent deviations in measured or calculated values that would be recognized by those of ordinary skill in the art. Furthermore, as used herein, when a component is referred to as being “on” another component, it can be directly on the other component or components may also be present therebetween. Moreover, when a component is component is referred to as being “coupled” to another component, it can be directly attached to the other component or intervening components may be present therebetween.

What is claimed is:

1. A pair of tongs, comprising:
a first arm comprising a first end opposite a second end and an inner surface;
a second arm comprising a first end opposite a second end and an inner surface, wherein the first arm and the second arm are coupled together at, or proximate, their first ends, such that the inner surface of the first arm faces the inner surface of the second arm, wherein the second end of the first arm is biased away from the second end of the second arm;
a first pin comprising a tip extending from the inner surface of the first arm in a direction toward the second arm;
a second pin comprising a tip extending from the inner surface of the second arm and in a direction towards the first arm, wherein the first and second pins are configured for engaging an object with their corresponding tips, wherein when the tips engage the object, no other part of the pair of tongs engages the object.

2. The tongs as recited in claim 1, further comprising:
a first prong extending from the first arm defining a first slot therebetween; and
a second prong extending from the second arm defining a second slot therebetween.

3. The tongs as recited in claim 2, wherein the first prong extends from proximate the second end of the first arm and in a direction away from the second end and toward the first end of the first arm, and wherein the second prong extends from proximate the second end of the second arm and in a direction away from the second end and toward the first end of the second arm.

4. The tongs as recited in claim 2, wherein a first slot is formed between the first arm and the first prong and a second slot is formed between the second arm and the second slot.

5. The tongs as recited in claim 1, wherein the first pin is located proximate the second end of the first arm and the second pin is located proximate the second end of the first arm.

6. The tongs as recited in claim 1, wherein each of said first and second pins is integrally formed with its corresponding arm.

7. The tongs as recited in claim 1, wherein each of said first and second pins is attached to its corresponding arm.

8. The tongs as recited in claim 1, wherein when the two arm second ends are compressed towards each other, a tip of the first pin engages a tip of the second pin.

9. The tongs as recited in claim 1, wherein the object is a coal used on hookah for burning tobacco.

10. The tongs as recited in claim 9, wherein when the first and second tips engage the coal along an axis below a center of gravity of the coal, said coal will rotate about said axis when lifted.

11. The tongs as recited in claim 1, wherein when the first and second tips engage the object along an axis below a center of gravity of the coal, said object will rotate about said axis when lifted.

12. A method of rotating a coal for use on a hookah comprising:
engaging the coal with opposite pins of a pair of tongs along an axis; and
lifting the engaged coal allowing the coal to rotate about said axis.

13. The method as recited in claim 12, further comprising pressing one of said pins toward the other of said opposite pins for stopping the rotation of the coal.

14. The method as recited in claim 12, wherein said axis is below a center of gravity of said coal.

15. The method as recited in claim 12, wherein engaging the coal comprises pressing one of said opposite pins towards the other of said opposite pins.

16. The method as recited in claim 12, wherein said coal rotates due to its own weight.
